(19) United States
(12) Patent Application Publication
(10) Pub. No.: US 2026/0301062 A1
(43) Pub. Date: Oct. 1, 2026

(54) ELECTRONIC COMMERCE SERVICE SYSTEM AND METHOD USING VIRTUAL FITTING FUNCTION

(71) Applicant: Kwanghun KIM, Yongin-si (KR)

(72) Inventor: Kwanghun KIM, Yongin-si (KR)

(73) Assignee: Kwanghun KIM, Yongin-si (KR)

(21) Appl. No.: 19/483,230

(22) PCT Filed: Jan. 24, 2024
(86) PCT No.: PCT/KR2024/001139

§ 371 Date: Nov. 10, 2025

(30) Foreign Application Priority Data
May 18, 2023 (KR) 10-2023-0064073

(51) Int. Cl. G06Q 30/0601; G06T 7/50; G06T 15/00; G06T 17/00

(52) U.S. Cl. CPC G06Q 30/06432; G06Q 30/06212; G06T 7/50; G06T 15/00; G06T 17/00; G06T 2207/30196

(57) ABSTRACT

The present invention relates to an electronic commerce service system and a method using a virtual fitting function. When a clothing product is purchased online, a physical wearing state is analyzed, predicted, and provided on the basis of related information of the clothing product and avatar information obtained by measuring a body of a user, and a return rate of the clothing product can thereby be reduced. In addition, by providing information similar to a wearing state offline, the present invention has an advantage of being able to apply various fashion items on the basis of body measurement data of a user.

### TECHNICAL FIELD

The present disclosure relates to an electronic commerce service system and an electronic commerce service method using a virtual fitting function and, more specifically, to an electronic commerce service system and electronic commerce service method using a virtual fitting function, wherein when a clothing product is purchased online, a physical wearing state is analyzed, predicted, and provided based on information related to the clothing product and avatar information obtained by measuring a user's body, thereby reducing the return rate of the clothing product.

### BACKGROUND ART

Recently, the shopping pattern related to product purchases has rapidly expanded from purchasing products at offline stores to purchasing products through online shopping malls, and accordingly, the related market has also exhibited significant growth.

To purchase products from an online shopping mall, a consumer accesses an online shopping mall through the Internet by using a terminal.

When the consumer accesses an online shopping mall through the terminal, the online shopping mall displays products provided by the online shopping mall to the consumer's terminal. The consumer then searches for a desired product while reviewing detailed information, such as the descriptions, functions, prices, and terms of sale of products, from a database constructed in the online shopping mall.

Furthermore, comparison online shopping mall, which provides comparative information about multiple shopping malls, compares prices offered by sellers selling a product selected by the consumer and guides the consumer to a seller offering the lowest price.

As described above, purchasing a clothing product through an online shopping mall has the advantage of allowing a consumer to shop with ease. However, it may be difficult to actually try on clothes. Furthermore, size information provided for the clothes includes only the measurements, and thus it may be difficult for the consumer to choose the correct size of a product that the consumer intend to purchase.

Furthermore, unlike offline purchasing, online purchasing has the drawback that a consumer cannot physically try on a clothing product, making it difficult for the consumer to verify information about the material of the product or the wearing state of the product.

Additionally, after online purchasing, the return rate tends to be very high due to the discrepancy between the consumer's actual fit and the model's fit shown online, thereby increasing the logistics and distribution costs associated with returns.

Furthermore, the packaging required for product shipment and the packaging materials generated by returns contribute to environmental pollution.

### DISCLOSURE OF INVENTION

### Technical Problem

To address these problems, an aspect of the present disclosure is to provide an electronic commerce service system and an electronic commerce service method using a virtual fitting function, wherein when a clothing product is purchased, the physical wearing state of the clothing product can be analyzed, predicted, and provided based on information related to the clothing product and avatar information obtained by measuring a user's body, thereby reducing the return rate of the clothing product.

### Solution to Problem

An embodiment of the present disclosure relates to an electronic commerce service system using a virtual fitting function, the electronic commerce service system including: a user terminal configured to access a transaction service server to perform electronic commerce for a product provided from an arbitrary seller terminal, analyze user body information from a captured image of a user's body to generate a user avatar, and display a virtual fitting image provided from the transaction service server; the transaction service server configured to manage electronic commerce performed between the seller terminal selling an arbitrary product and the user terminal, and in case that a request for fitting of a product is made from the user terminal, receive user avatar information and product specification information, which includes color, product design information, size information, function information, material information, and elasticity information related to the product, from the user terminal and the seller terminal to generate a virtual fitting image, perform fitting through simulation corresponding to the user's physical wearing state by reflecting the size information, the function information, the material information, the elasticity information, and wrinkle information included in the product specification information in product deformation according to the user avatar's movement through an artificial intelligence-based fitting prediction model, analyze and predict a physical wearing state through fitting, the physical wearing state referring to a state in which the product is stretched or wrinkled due to the user directly wearing the product, and generate a virtual fitting image in which the physical wearing state is reflected in the user avatar, the virtual fitting image being generated by reflecting arbitrary background and environmental images in the user avatar during a fitting simulation reflecting the product specification information, analyze a product deformation state, based on the virtual fitting image, depending on the product's size and the product's size, function, material, elasticity, and wrinkle according to the user avatar's movement, and generate and output product fitting evaluation information based on a deformation result of the product; and the seller terminal configured to access the transaction service server, provide at least one product and product information of the product, and perform electronic commerce for the product with the user terminal.

The user terminal according to the embodiment includes: an input unit configured to receive user information and electronic commerce information from the user; a 3D measurement unit configured to capture an image of the user's body and output the image as a three-dimensional image; a display unit configured to output the captured three-dimensional image, the user avatar, and the virtual fitting image provided by the transaction service server; a control unit configured to execute an avatar generation application program to analyze an object from three-dimensional image information of the 3D measurement unit, generate a user avatar by reflecting depth information of the analyzed object as the user body information, execute an electronic commerce application program to request product fitting from the transaction service server, and control electronic commerce to be performed with the seller terminal; and a data communication unit configured to transmit and receive the user information, the electronic commerce information, the user avatar information, fitting request information, and the virtual fitting image.

Furthermore, the user terminal according to the embodiment further includes an imaging unit configured to photograph a one-dimensional or two-dimensional information display means displaying arbitrary product information, and the control unit is configured to analyze seller information and product information from the photographed information display means, request product fitting based on the product information from the transaction service server, and control electronic commerce based on the seller information to be performed with the seller terminal.

The 3D measurement unit according to the embodiment is configured to calculate depth information relative to an object by using either structured light (SL) or time of flight (TOF), and output the user's body size information, based on the calculated depth information.

Furthermore, the control unit according to the embodiment is configured to correct the generated user avatar by using a digital twin program and store the correction result in the user terminal.

Furthermore, the transaction service server according to the embodiment includes: a data communication unit configured to transmit and receive user information, electronic commerce information, user avatar information, fitting request information, seller information, product information including product specification information, and virtual fitting image information with at least one of the user terminal, the seller terminal, a manufacturer terminal, and an SNS server; a member management unit configured to manage user authentication and seller authentication, based on the user information and the seller information; a product management unit configured to store the product information and product specification information including product design information including color, size information, function information, material information, elasticity information, and wrinkle information; an electronic commerce unit configured to manage electronic commerce for an arbitrary product performed between the user terminal and the seller terminal; and a fitting management unit configured to perform, in case that a request for fitting of a product is made from the user terminal, fitting through a simulation corresponding to the user's physical wearing state by reflecting the size information, the function information, the material information, the elasticity information, and wrinkle information included in the product specification information in product deformation according to the user avatar's movement by using an artificial intelligence-based fitting prediction model, based on user avatar information and product information received from the user terminal and the seller terminal, product specification information of the product stored in the product management unit, and arbitrary background and environmental information during a fitting simulation reflecting the product specification information, generate corrected user avatar reflecting product deformation prediction information corresponding to a physical wearing state through the fitting, render the corrected user avatar photorealistically by using a photorealistic rendering model, generate the photorealistically rendered user avatar as a virtual fitting image, analyze a product deformation state, based on the virtual fitting image, depending on the product's size and the product'size, function, material, elasticity, and wrinkle according to the user avatar's movement, and generate and output product fitting evaluation information based on a deformation result of the product.

Furthermore, the fitting management unit according to the embodiment includes: an avatar information input unit configured to receive user avatar information from the user terminal in case that a request for fitting of a product is made; a product information input unit configured to receive the product information and the product specification information; a product information analysis unit configured to analyze product design information including color, size information, function information, material information, and elasticity information from the product specification information; an artificial intelligence fitting unit configured to generate a virtual fitting image by using an artificial intelligence-based fitting prediction model, perform fitting through a simulation corresponding to the user's physical wearing state by reflecting size information, function information, material information, elasticity information, and wrinkle information in product specification information according to the user avatar's movement, based on the product specification information and arbitrary background and environmental information during a fitting simulation reflecting the product specification information, correct the user avatar by reflecting product deformation prediction information corresponding to the physical wearing state through the fitting, render the corrected user avatar photorealistically by using a photorealistic rendering model, and generate the photorealistically rendered user avatar as a virtual fitting image; and a fitting evaluation unit configured to analyze a product deformation state, based on the virtual fitting image, depending on the product's size and the product's size, function, material, elasticity, and wrinkle according to the user avatar's movement, and convert the product fitting evaluation information based on the deformation result of the product into an arbitrary format and output the converted information.

Furthermore, the artificial intelligence fitting unit according to the embodiment is configured to identify whether SNS information is input from the user terminal, transmit the generated virtual fitting image to the SNS server corresponding to the SNS information in case that the input of the SNS information is identified, and output response information received from the SNS server to the fitting evaluation unit.

Furthermore, the fitting evaluation unit according to the embodiment is configured to additionally generate product customizing information, based on the generated fitting evaluation information and output the customizing information to the user terminal.

Furthermore, the fitting evaluation unit according to the embodiment is configured to, in case that a purchase request corresponding to the customizing information is input from the user terminal, request electronic commerce by transmitting the customizing information for custom manufacturing, user information, and product specification information to the manufacturer terminal via the electronic commerce unit.

Furthermore, an embodiment of the present disclosure relates to an electronic commerce service method using a virtual fitting function, the electronic commerce service method including: step a) in which a user terminal analyzes user body information from a captured image of a user's body to generate a user avatar; step b) in which the user terminal accesses a transaction service server to perform electronic commerce for a product provided from an arbitrary seller terminal; step c) in which the transaction service server manages electronic commerce performed between the user terminal and the seller terminal and determines whether a request for fitting for a product is made from the user terminal, and in case that the request for fitting of the product is made, the transaction service server receives user avatar information and product specification information, which includes color, product design information, size information, function information, material information, and elasticity information related to the product, from the user terminal and the seller terminal; step d) in which the transaction service server performs fitting through a simulation corresponding to the user's physical wearing state by reflecting the size information, the function information, the material information, the elasticity information, and wrinkle information included in the product specification information in product deformation according to the user avatar's movement through an artificial intelligence-based fitting prediction model, generates a corrected user avatar reflecting product deformation prediction information corresponding to a physical wearing state through the fitting, renders the corrected user avatar photorealistically by using a photorealistic rendering model, and generates the photorealistically rendered user avatar as a virtual fitting image; and step e) in which the transaction service server analyzes a product deformation state, based on the virtual fitting image, depending on the product's size and the product' size, function, material, elasticity, and wrinkle according to the user avatar's movement, and generate and output product fitting evaluation information based on a deformation result of the product.

Furthermore, the step a) according to the embodiment includes: a body scanning step a-1) in which the user terminal captures an image of the user's body and outputs the image as a three-dimensional image; and a step a-2) in which the user terminal analyzes an object from the captured three-dimensional image information, generates a user avatar reflecting depth information of the analyzed object as the user body information, corrects the user avatar by using a digital twin program, and stores the user avatar reflecting the correction result in the user terminal.

Furthermore, the step b) according to the embodiment further includes a step in which the user terminal photographs a one-dimensional or two-dimensional information display means displaying arbitrary product information, analyzes seller information and product information from the photographed information display means, requests product fitting based on the product information from the transaction service server, and performs electronic commerce based on the seller information with the seller terminal.

Furthermore, the step e) according to the embodiment includes a step in which the transaction service server identifies whether SNS information is input from the user terminal, transmits the generated virtual fitting image to an SNS server corresponding to the SNS information in case that the input of the SNS information is identified, and reflects response information received from the SNS server in the product fitting evaluation information.

Furthermore, in the step e) according to the embodiment, the transaction service server additionally generates product customizing information, based on the generated fitting evaluation information, and outputs the customizing information to the user terminal.

Furthermore, the electronic commerce service method according to the embodiment further includes step f) in which the transaction service server determines whether a product order has been completed, and in case that either the product's predefined information or customizing information is input from the user terminal, transmits product specification information for an electronic commerce unit, the customizing information for custom manufacturing, and user information to the seller terminal or a manufacturer terminal to perform electronic commerce.

### Advantageous Effects of Invention

The present disclosure is advantageous in that when a clothing product is purchased, a physical wearing state may be analyzed, predicted, and provided based on information related to the clothing product and avatar information obtained by measuring a user's body, thereby reducing the return rate of the clothing product.

Furthermore, the present disclosure is advantageous in that information similar to an offline wearing state is provided, thereby enabling the application of various fashion items based on the user's body measurement data.

Furthermore, the present disclosure is advantageous in that a fitting information management platform may be provided based on avatar information obtained by measuring the user's body, thereby enabling a collaborative system between a shopping mall selling ready-made clothing and a manufacturer producing custom clothing by using information customized for a user.

Furthermore, the present disclosure is advantageous in that individual fitting information may be managed based on avatar information obtained by measuring the user's body and SNS content information may be produced and managed through the wearing of various clothing products.

### BRIEF DESCRIPTION OF DRAWINGS

FIG. 1 is a block diagram illustrating the configuration of an electronic commerce service system using virtual fitting function according to an embodiment of the present disclosure.

FIG. 2 is an exemplary diagram illustrating the operation of the electronic commerce service system using a virtual fitting function according to the embodiment of FIG. 1.

FIG. 3 is a block diagram illustrating the configuration of a user terminal in the electronic commerce service system using a virtual fitting function according to the embodiment of FIG. 1.

FIG. 4 is an exemplary diagram illustrating the operation of the electronic commerce service system using a virtual fitting function according to the embodiment of FIG. 1.

FIG. 5 is another exemplary diagram illustrating the operation of the electronic commerce service system using a virtual fitting function according to the embodiment of FIG. 1.

FIG. 6 is a block diagram illustrating the configuration of a transaction service server in the electronic commerce service system using a virtual fitting function according to the embodiment of FIG. 1.

FIG. 7 is a block diagram illustrating the configuration of a fitting management unit of the transaction service server according to the embodiment of FIG. 6.

FIG. 8 is a flowchart illustrating an electronic commerce service method using a virtual fitting function according to an embodiment of the present disclosure.

FIG. 9 is a flowchart illustrating the user body measurement step of the electronic commerce service method using a virtual fitting function according to the embodiment of FIG. 8.

FIG. 10 is a flowchart illustrating the artificial intelligence-based fitting step of the electronic commerce service method using the virtual fitting function according to the embodiment of FIG. 8.

FIG. 11 is a flowchart illustrating the product ordering step of the electronic commerce service method using a virtual fitting function according to the embodiment of FIG. 8.

### BEST MODE FOR CARRYING OUT THE INVENTION

Hereinafter, the present disclosure will be described in detail with reference to preferred embodiments and the accompanying drawings, assuming that the same reference numerals denote the same components in the drawings.

Before describing the specific details for implementing the present disclosure, it should be noted that configurations not directly related to the technical gist of the present disclosure have been omitted without dispersing the technical gist of the present disclosure.

Furthermore, the terms or words used in this specification and the claims should be interpreted in a meaning and concept consistent with the technical sprit of the disclosure, based on the principle that the inventor may define the concept of an appropriate term to describe his/her invention in the best manner.

In this specification, the expression that a part “includes” a component does not exclude other components but means that the part may further include other components.

Furthermore, a term such as “unit,” “device,” or “module” denote a unit that performs at least one function or operation, and the unit may be hardware, software, or a combination thereof.

Furthermore, the term “at least one” is defined as encompassing both singular and plural forms. It is self-evident that even in the absence of the term “at least one”, each component may exist in singular or plural form and may imply singular or plural meaning.

Hereinafter, a preferred embodiment of an electronic commerce service system and an electronic commerce service method using a virtual fitting function according to an embodiment of the present disclosure will be described in detail with reference to the accompanying drawings.

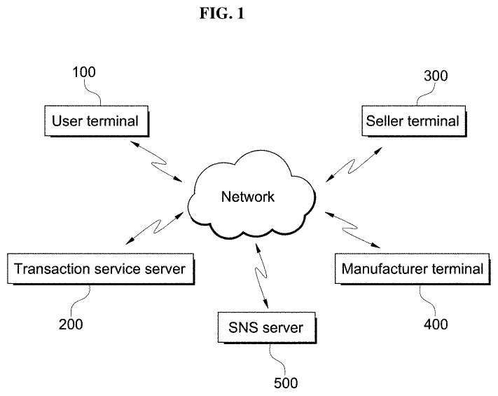

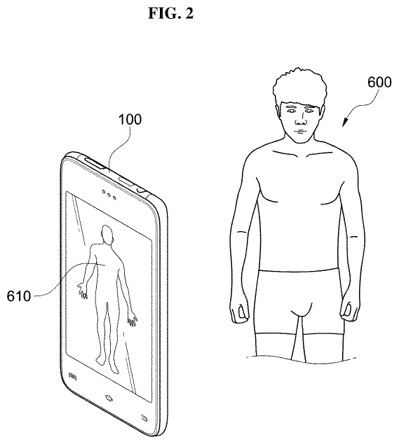

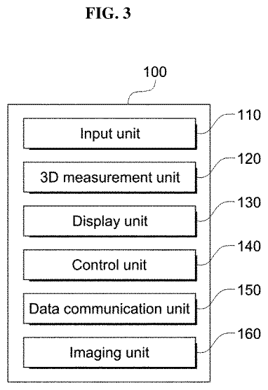

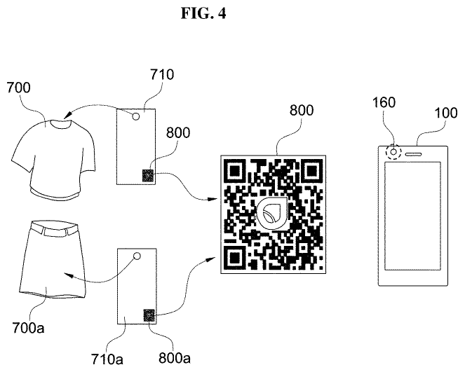

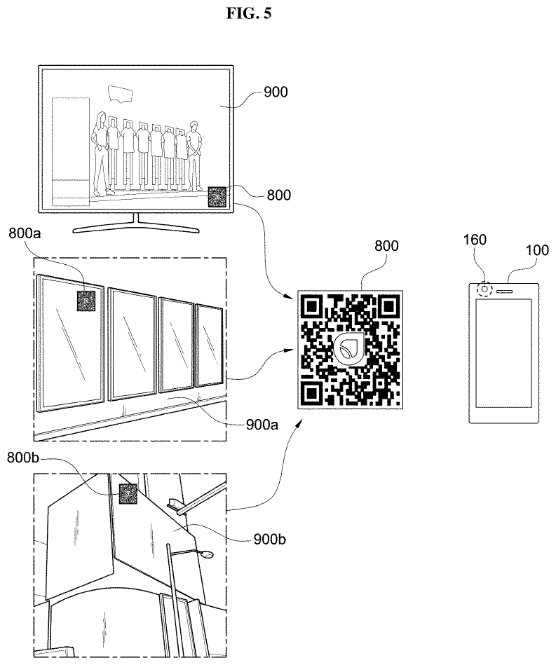

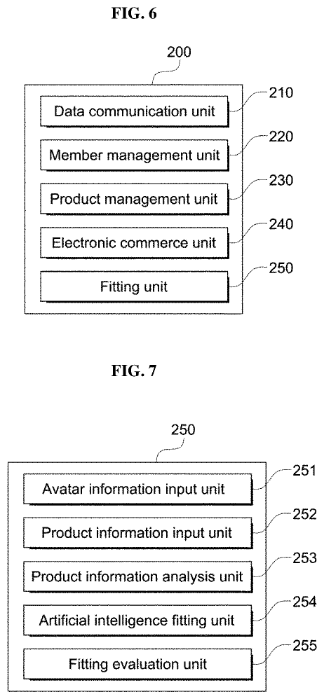

FIG. 1 is a block diagram illustrating the configuration of an electronic commerce service system using a virtual fitting function according to an embodiment f the present disclosure. FIG. 2 is an exemplary diagram illustrating the operation of the electronic commerce service system using a virtual fitting function according to the embodiment of FIG. 1. FIG. 3 is a block diagram illustrating the configuration of a user terminal in the electronic commerce service system using a virtual fitting function according to the embodiment of FIG. 1. FIG. 4 is an exemplary diagram illustrating the operation of the electronic commerce service system using a virtual fitting function according to the embodiment of FIG. 1. FIG. 5 is another exemplary diagram illustrating the operation of the electronic commerce service system using a virtual fitting function according to the embodiment of FIG. 1. FIG. 6 is a block diagram illustrating the configuration of a transaction service server in the electronic commerce service system using a virtual fitting function according to the embodiment of FIG. 1. FIG. 7 is a block diagram illustrating the configuration of a fitting management unit of the transaction service server according to the embodiment of FIG. 6.

Referring to FIGS. 1 to 7, an electronic commerce service system using a virtual fitting function according to an embodiment of the present disclosure may include a user terminal 100, a transaction service server 200, a seller terminal 300, a manufacturer terminal 400, and an SNS server 500 so that when a clothing product is purchased online, a physical wearing state may be analyzed, predicted, and provided based on information related to the clothing product and avatar information obtained by measuring a user's body, thereby reducing the return rate of the clothing product.

The user terminal 100 may access the transaction service server 200 via a network and perform electronic commerce for products provided by at least one seller terminal 300.

Here, the electronic commerce between the user terminal 100 and the seller terminal 300 may be identical to the known electronic commerce process.

Furthermore, the user terminal 100 may be a component configured to generate a user avatar 610 to enable virtual fitting for products such as clothing that a user 600 cannot physically try on online. The user terminal may be configured as a desktop PC, a notebook PC, a tablet PC, a mobile terminal in which applications can be installed, or an embedded terminal capable of capturing three-dimensional images.

Furthermore, the user terminal 100 does not require a special place or device, and the user may directly capture images by using a camera which the user terminal has.

In the present embodiment, for the convenience of description, a mobile terminal (e.g., a smartphone) equipped with a Lidar sensor, time of flight (TOF), 3D camera SDK, etc. is described as an example, but the disclosure is not limited thereto.

Furthermore, the user terminal 100 may analyze user body information from a captured image of the body of the user 600 to generate a user avatar 610, receive and display a virtual fitting image provided from the transaction service server 200, and may include an input unit 110, a 3D measurement unit 120, a display unit 130, a control unit 140, a data communication unit 150, and an imaging unit 160.

The input unit 110 may receive, from the user 600, user information, electronic commerce information, and configuration information for generating and transmitting the user avatar 610.

The 3D measurement unit 120 is a component configured to capture an image of the body of the user 600 and output the image as a three-dimensional image. The 3D measurement unit 120 may calculate depth information relative to an object by using either structured light (SL) or time of flight (ToF) and may include a 3D camera, a two-dimensional camera including a Lidar sensor, etc.

Furthermore, the 3D measurement unit 120 may output the user's body size information, based on the calculated depth information relative to the object.

Here, the user's body size may include height, arm length, leg length, head size, waist circumference, torso circumference, head circumference, neck circumference, foot size, hand size, etc.

The display unit 130 may output the captured three-dimensional image including depth information, the user avatar 610, and the virtual fitting image provided from the transaction service server 200.

The control unit 140 may execute an application program for electronic commerce to perform electronic commerce with the seller terminal 300 via the transaction service server 200.

Furthermore, when the electronic commerce item is a clothing product, the control unit 140 may request fitting of the product from the transaction service server 200.

Furthermore, when a product fitting request is made, the control unit 140 may analyze an object from three-dimensional image information measured by the 3D measurement unit 120 and generate a user avatar 610 based on depth information corresponding to the analyzed object, i.e., user body information.

Here, the fitting request is a request for matching a clothing product for purchase to the user avatar 610 generated on the user terminal 100, and evaluating the wearing comfort and the wearing condition, for example, sleeve length, leg length, torso circumference, or waist circumference, the elasticity and wrinkling 4 the clothing, etc. in a virtual physical state, which is a physical state in which the user directly wears the clothing offline, wherein the physical wearing state refers to a state in which the product is stretched or wrinkled when the user directly wearing the product.

That is, when a fitting request is input, the control unit 140 may execute an avatar generation application program, analyze a photographed three-dimensional image object from the three-dimensional image information of the 3D measurement unit 120, and then reflect the analyzed object's depth information as the user body information to generate the user avatar 610.

Furthermore, the control unit 140 may correct the generated user avatar 610 by using a digital twin program, and the corrected user avatar 610 may be stored in the user terminal 100.

Here, the digital twin program creates virtual model of assets such as physical objects, spaces, environments, people, and processes by using software, enabling the models to operate or perform identical actions as in the real world. This allows potential issues to be identified and resolved through simulation before making an actual product.

Furthermore, the digital twin program may be installed and operated on the user terminal 100, but the digital twin program may also be installed and operated on the transaction service server 200, the seller terminal 300, or the manufacturer terminal 400 accessed via a network.

Furthermore, the control unit 140 may use a previously stored user avatar 610, or update the same to a newly generated user avatar 610 if additional generation is requested by the user.

Furthermore, when a virtual fitting image is received from the transaction service server 200, the control unit 140 may request that the received virtual fitting image be transmitted to the SNS server 500 based on arbitrary SNS information that is input by the user.

Moreover, the control unit 140 may transmit, to the transaction service server 200, response information regarding the virtual fitting image received from the SNS server 500.

Furthermore, the control unit 140 may analyze an image of an information display means 800, 800a, or 800b captured by the imaging unit 160 to extract seller information and product information.

Here, the information display means 800, 800a, or 800b may include a one-dimensional information display means, such as “barcode,” or a two-dimensional information display means, such as a “QR code.”

Meanwhile, in the present embodiment, for convenience of description, a one-dimensional or two dimensional information display means is described as an example, but the present disclosure is not limited thereto, and any information display means capable of displaying seller information and product information may be included.

Furthermore, the control unit 140 may request fitting of the relevant product from the transaction service server 200, based on the extracted product information.

Furthermore, the control unit 140 may control, based on the extracted seller information, electronic commerce with the seller terminal 300 to be performed via the transaction service server 200.

The data communication unit 150 may transmit and receive user information, electronic commerce information, user avatar 610 information, fitting request information, virtual fitting images, etc., to and from the transaction service server 200, the seller terminal 300, the manufacturer terminal 400, or the SNS server 500.

The imaging unit 160 is a component configured to output a captured image of a one-dimensional or two dimensional information display means displaying arbitrary product information, and may be configured as a camera including a CCD sensor, a CMOS sensor, or any sensor that converts optical signals into electrical signals.

That is, the imaging unit 160 may output a captured image of the information display means 800 or 800a, such as a “QR code,” in a product tag 710 or 710a attached to a product 700 or 700a offline.

Furthermore, the imaging unit 160 may output an image obtained by photographing the information display means 800 displayed on one side of online advertising information 900 exposed on a display screen, or the information display means 800a or 800b displayed on one side of outdoor advertising information 900a or 900b installed at arbitrary locations and exposed.

Furthermore, when a request for fitting of a product, such as fitting of a clothing product, is made from the user terminal 100, the transaction service server 200 may receive product specification information related to the product and user avatar 610 information from the user terminal 100 and the seller terminal 300.

Furthermore, the transaction service server 200 may generate a virtual fitting image, and may use an artificial intelligence-based fitting prediction model to perform fitting that reflects the deformation of a product due to movement of the user avatar 610, based on product specification information.

Furthermore, the transaction service server 200 may analyze and predict a physical wearing state through fitting to generate a virtual fitting image in which the physical wearing state is reflected in the user avatar 610, and may generate and output product fitting evaluation information.

To this end, the transaction service server 200 may include a data communication unit 210, a member management unit 220, a product management unit 230, an electronic commerce unit 240, and a fitting management unit 250.

The data communication unit 210 may transmit and receive user information, electronic commerce information, user avatar 610 information, fitting request information, seller information, product specification information, virtual fitting images, etc. to and from the user terminal 100, the seller terminal 300, the manufacturer server 400, the SNS server 500, etc.

The member management unit 220 may manage user authentication and seller authentication, based on user information input from the user terminal 100 and seller information input from the seller terminal 300.

The Product management unit 230 may receive, from the seller terminal 300, product information and product specification information such as product design information including color, size information, function information for attaching/detaching a part (e.g., a sleeve, a leg, or a hat) of a product, material information, elasticity information, and wrinkle information, and store and management the product information and the product specification information.

The electronic commerce unit 240 is a component that manages electronic commerce for a product performed between the user terminal 100 and the seller terminal 300 or between the user terminal 100 and the manufacturer terminal 400. The electronic commerce unit may be configured using known electronic commerce means.

The fitting management unit 250 may receive user avatar 610 information from the user terminal 100 when a request for fitting of a product is made from the user terminal 100, and may receive information about the product subject to the fitting request from the seller terminal 300.

Furthermore, the fitting management unit 250 may generate a virtual fitting image based on the received user avatar 610 information and product information, along with the product specification information for the product stored in the product management unit 230.

That is, the fitting management unit 250 may generate a corrected user avatar 610 by reflecting product deformation prediction information corresponding to the physical wearing state based on the movement of the user avatar 610 by using an artificial intelligence-based fitting prediction model.

To this end, the fitting management unit 250 may analyze the deformation of the product through fitting that reflects the product specification information in the movement of the user avatar 610.

Here, the artificial intelligence-based fitting prediction model may be considered a type of analytical model developed using deep learning, which is a method within machine learning.

Therefore, the artificial intelligence-based fitting prediction model may also be referred to as a deep learning model or a deep learning analysis model.

Furthermore, machine learning is an application of artificial intelligence that enables complex systems to learn and improve automatically from experience, without being explicitly programmed.

Moreover, the accuracy and validity of machine learning models may partially depend on the data used to train the models.

Additionally, the fitting management unit 250 may generate a virtual fitting image in which the result of the product deformation analysis through fitting is reflected in the user avatar 610.

That is, the fitting management unit 250 may perform photorealistic rendering using a photorealistic rendering model on the corrected user avatar 610 reflecting the product deformation analysis result, thereby performing fitting that generates the photorealistically rendered user avatar 610 as a virtual fitting image.

Here, the photorealistic rendering model is an artificial intelligence-based program, and may be configured as a generative adversarial network (GAN), which generates a virtual fitting image resembling reality by comparing various pieces of data.

Furthermore, the fitting management unit 250 may generate and output product fitting evaluation information based on the virtual fitting image.

To this end, the fitting management unit 250 may include an avatar information input unit 251, a product information input unit 252, a product information analysis unit 253, an artificial intelligence fitting unit 254, and a fitting evaluation unit 255.

When fitting for a product is requested, the avatar information input unit 251 may receive user avatar 610 information from the user terminal 100.

When a request for fitting of an arbitrary product is made from the user terminal 100, the product information input unit 252 may receive product information and product specification information related to the product from the seller terminal 300 and the product management unit 230.

The product information analysis unit 253 may receive and analyze product design information including color, size information, function information, material information, elasticity information, wrinkle information, etc., from the product specification information.

The artificial intelligence fitting unit 254 may use an artificial intelligence-based fitting prediction model to perform a simulation corresponding to the user's physical wearing state through fitting that reflects the product information and product specification information, based on movement of the user avatar 610.

Furthermore, the artificial intelligence fitting unit 254 may correct the user avatar 610 by reflecting product deformation prediction information in the user avatar 610 through the simulation, analyze the product deformation result reflecting product specification information through fitting, and generate a virtual fitting image in which the product deformation prediction information is reflected in the user avatar 610.

Moreover, the artificial intelligence fitting unit 254 may generate a virtual fitting image by reflecting various background images and environmental images during the fitting simulation that reflects the product specification information in the user avatar 610.

Furthermore, the artificial intelligence fitting unit 254 may perform photorealistic rendering using a photorealistic model, which generates a virtual fitting image resembling reality, while comparing various data, on the user avatar 610 corrected by reflecting the product deformation analysis result, and perform fitting that generates the photorealistically rendered user avatar 610 as a virtual fitting image.

The fitting evaluation unit 255 may analyze a product deformation state based on fitting evaluation information of the product based on the virtual fitting image, such as the size of the product corresponding to the user avatar 610, and the product's size, material, elasticity, wrinkle, etc. corresponding to the movement of the user avatar 610.

Furthermore, the fitting evaluation unit 255 may transmit, to the user terminal 100, the analyzed product deformation state and the virtual fitting image generated by reflecting the same.

Furthermore, the fitting evaluation unit 255 may identify whether SNS information for transmitting the virtual fitting image is input from the user terminal 100 via the SNS server 500, and transmit a virtual fitting image generated based on the input SNS information to the SNS server 500.

Furthermore, when response information is received from the SNS server 500 in response to the virtual fitting image, the fitting evaluation unit 255 may reflect the response information in product fitting evaluation information corresponding to the virtual fitting image.

Furthermore, the fitting evaluation unit 255 may convert the result of the product deformation state analysis into a visual format such as a virtual fitting image and text, and the converted information may be output via the user terminal 100.

Furthermore, the fitting evaluation unit 255 may additionally generate product customizing information, based on the generated fitting evaluation information.

In other words, the fitting evaluation unit 255 may generate optimal customization information tailored to the user's body size, based on the user avatar 610 information, in a case in which certain dimensions of a product, such as sleeve length, pant length, waist circumference, or chest circumference, are larger or smaller.

Furthermore, the fitting evaluation unit 255 may output the generated customization information to the user terminal 100. When a purchase request corresponding to the generated customization information is input from the user terminal 100, the fitting evaluation unit 255 may search for manufacturers in order to request custom manufacturing and then output at least one found manufacturer terminal 400 to the user terminal 100.

Furthermore, the fitting evaluation unit 255 may transmit the customization information, user information, and product specification information to a manufacturer terminal 400 selected by the user terminal 100, and requests the electronic commerce unit 240 to facilitate electronic commerce between the user terminal 100 and the manufacturer terminal 400 for the production of custom clothing.

The seller terminal 300 may access the transaction service server 200 via a network to provide at least one product and product information of the product, and may perform electronic commerce for the product with the user terminal 100.

Additionally, the seller terminal 300 may provide the transaction service server 200 with product specification information, such as product design information including the color of the product, size information, function information, material information, elasticity information, and wrinkle information, along with the product information.

The manufacturer terminal 400 may access the transaction service server 200 via a network. When a request for custom manufacturing based on the customization information from the user terminal 100 is received through the transaction service server 200, the manufacturer terminal 400 may receive the customization information, the user information, and the product specification information from the user terminal 100 or the transaction service server 200 to enable the manufacturing of a clothing product, i.e., the custom clothing.

The following describes an electronic commerce service method using a virtual fitting function according to an embodiment of the present disclosure.

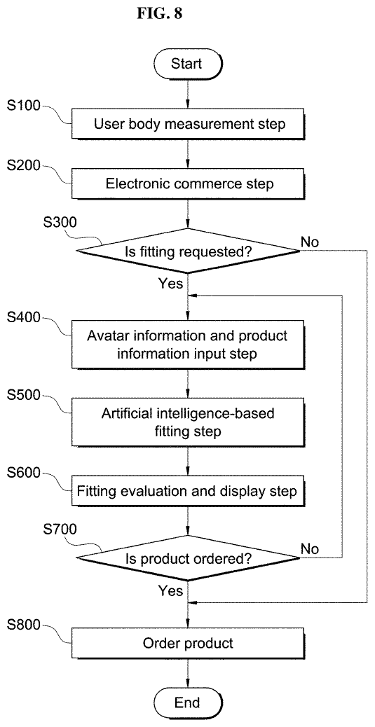

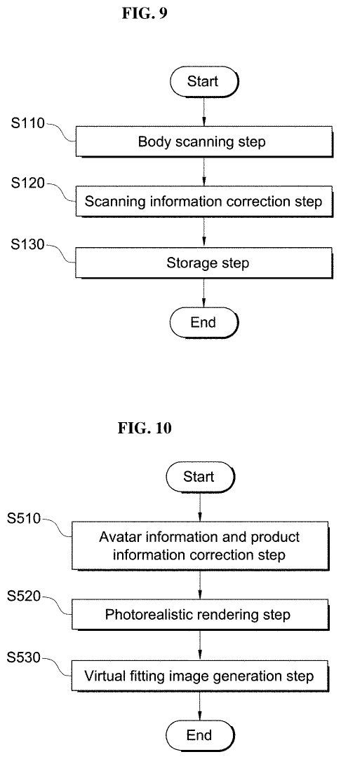

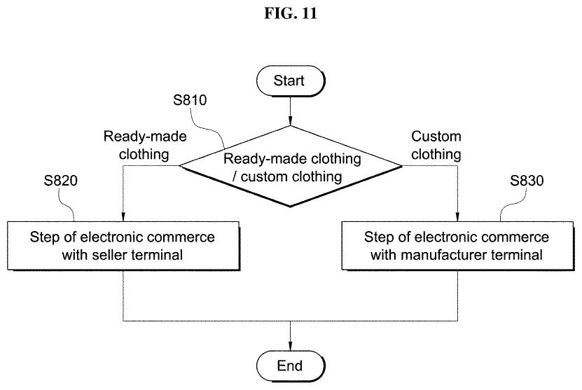

FIG. 8 is a flowchart illustrating an electronic commerce service method using a virtual fitting function according to an embodiment of the present disclosure. FIG. 9 is a flowchart illustrating the user body measurement step of the electronic commerce service method using a virtual fitting function according to the embodiment of FIG. 8. FIG. 10 is a flowchart illustrating the artificial intelligence-based fitting step of the electronic commerce service method using the virtual fitting function according to the embodiment of FIG. 8. FIG. 11 is a flowchart illustrating the product ordering step of the electronic commerce service method using a virtual fitting function according to the embodiment of FIG. 8.

Referring to FIGS. 1 and 11, the electronic commerce service method using a virtual fitting function according to an embodiment of the present disclosure measures and analyze user body information from an image of the body of the user 600 captured by the user terminal 100 (S100).

That is, in step S100, the user terminal 100 may perform a body scan for capturing image of the body of the user 600 and outputting the image as a three-dimensional image (S110), and output the three-dimensional image.

Furthermore, the user terminal 100 may analyze an object from the captured three-dimensional image information and generates a user avatar 610 in which the analyzed object's depth information is reflected as the user body information, correct the user avatar 610 by using a digital twin program (S120), and store the corrected user avatar 610 in the user terminal 100 (S130).

In this case, the user terminal 100 may calculate the user's body size information based on the analyzed depth information and reflect the calculated user's body size information in the user avatar 610.

Furthermore, when a one-dimensional or two-dimensional information display means 800, 800a, or 800b displaying arbitrary product information captured via the imaging unit 160 is input, the user terminal 100 may analyze an image of the input information display means 800, 800a, or 800b to extract seller information and product information.

Furthermore, based on the extracted product information and seller information, the user terminal 100 may make a request to the transaction service server 200 for fitting of a relevant product and for electronic commerce with the seller terminal 300 of the relevant product.

Furthermore, the user terminal 100 may access the transaction service server 200 and perform electronic commerce for a product provided by an arbitrary seller terminal 300 (S200).

Subsequently, the transaction service server 200 manages the electronic commerce in step S200 performed between the user terminal 100 and the seller terminal 300, and determines whether a request for fitting of the product is made by the user terminal 100 (S300).

As a result of the determination in step S300, when the fitting of the product is requested by the user terminal 100, the transaction service server 200 may receive product specification information related to the product and user avatar 610 information from the user terminal 100 and the seller terminal 300 (S400), and may generate a virtual fitting image based on the received information.

Here, the product specification information may include product design information including color, size information, function information, material information, elasticity information, wrinkle information, etc.

Subsequently, the transaction service server 200 may generate a corrected user avatar 610 reflecting product deformation prediction information corresponding to the physical wearing state based on the movement of the user avatar 610 through an artificial intelligence-based fitting prediction model, photorealistically renders the corrected user avatar 610 by using a photorealistic rendering model, and generate the photorealistically rendered user avatar 610 as a virtual fitting image to perform fitting (S500).

To explain this in more detail, in step S500, the transaction service server 200 uses an artificial intelligence-based fitting prediction model to perform a simulation corresponding to the user's physical wearing state through fitting reflecting product information and product specification information according to the movement of the user avatar 610, and performs correction by reflecting product deformation prediction information predicted through the simulation in the user avatar 610 (S510).

Furthermore, the transaction service server 200 performs photorealistic rendering using a photorealistic model, which generates a virtual fitting image resembling reality, while comparing various data, on the user avatar 610 corrected by reflecting the product deformation analysis result (S520), and generates the photorealistically rendered user avatar 610 as a virtual fitting image (S530).

Furthermore, in step S510, during the fitting simulation reflecting the product specification information in the user avatar 610, the transaction service server 200 may generate a virtual fitting image by reflecting various background images and environmental images.

Subsequently, the transaction service server 200 generates product fitting evaluation information based on the result of product deformation as the user avatar 610 performs arbitrary movements, and outputs the generated product fitting evaluation information to be displayed via the user terminal 100 (S600).

Furthermore, in step S600, the transaction service server 200 may identify whether SNS information for transmitting the virtual fitting image is input from the user terminal 100 via the SNS server 500, and transmit the generated virtual fitting image to the SNS server 500 based on the input SNS information.

Furthermore, when response information regarding the virtual fitting image is received from the SNS server 500, the transaction service server 200 may reflect the received response information in the product fitting evaluation information corresponding to the virtual fitting image.

Furthermore, in step S600, the transaction service server 200 may additionally generate product customizing information, i.e., optimized size information, based on the generated fitting evaluation information, search for manufacturer information according to customizing, and output at least one piece of found manufacturer information to the user terminal 100.

In this case, the transaction service server 200 may provide the user terminal 100 with the manufacturer information along with separate condition information, such as a price and a return condition different from that of ready-made products (ready-made clothes).

Furthermore, in step S600, when a purchase request corresponding to the customization information is input from the user terminal 100, the transaction service server 200 may extract the customization information for custom manufacturing, user information, and product specification information and transmit the extracted information to the manufacturer terminal 400.

After performing step S600, the transaction service server 200 determines whether the product order has been completed (S700).

When, as a result of the determination in step S700, product order completion information is input from the user terminal 100, electronic commerce for the product is performed through the product order (S800).

That is, in step S800, the transaction service server 200 determines whether either ready-made clothing order information based on the product's predefined information or custom clothing order information based on the customizing information is input.

When, as a result of the determination in step S810, ready-made clothing order information is input, the transaction service server 200 transmits product specification information and user information for electronic commerce to the seller terminal 300, thereby enabling the electronic commerce to be performed between the seller terminal 300 and the user terminal 100 (S820).

Furthermore, when, as a result of the determination in step S810, custom clothing order information is input, the transaction service server 200 transmits customizing information, product specification information, and user information for electronic commerce to the manufacturer terminal 400, thereby enabling electronic commerce to be performed between the manufacturer terminal 400 and the user terminal 100 (S830).

Therefore, when purchasing a clothing product online, the physical wearing state may be analyzed and predicted based on information related to the clothing product and avatar information obtained by measuring the user's body, thereby reducing the return rate of the clothing product.

Furthermore, by providing information similar to the wearing state offline, various fashion items may be applied based on the user's body measurement data.

Furthermore, by providing a fitting information management platform based on the avatar information obtained by measuring the user's body, a collaborative system may be provided between shopping malls selling ready-made clothing and manufacturers producing custom clothing using information customized for the user.

Furthermore, based on the avatar information obtained by measuring the user's body, individual fitting information may be managed, and SNS content information may be produced and managed through the wearing of various clothing products.

As described above, the description has been made with reference to preferred embodiments of the present disclosure, but those skilled in the art will understand that the present disclosure may be modified and altered in various ways without departing from the spirit and scope of the present disclosure as defined in the appended claims.

Furthermore, the reference numerals used in the claims of the present disclosure are provided solely for clarity and convenience of description and the present disclosure is not limited thereto. In the course of describing the embodiments, the thickness of lines or the sizes of components depicted in the drawings may be exaggerated for clarity and convenience of description.

Furthermore, the interpretation of the aforementioned terms defined in consideration of the functions thereof in the present disclosure should be based on the overall content of this specification.

Furthermore, it is evident that those skilled in the art to which the present disclosure pertains may make various modifications embodying the technical sprit of the present disclosure from the description of the present disclosure, even if not explicitly illustrated or described, and such modifications shall still fall within the scope of the present disclosure.

Moreover, the embodiments described with reference to the accompanying drawings are described for the purpose of explaining the present disclosure, and the scope of the present disclosure is not limited to these embodiments.

### DESCRIPTION OF SYMBOLS

100: User terminal 110: Input unit
120: 3D measurement unit 130: Display unit
140: Control unit 150: Data communication unit
160: Imaging unit 200: Transaction service server
210: Data communication unit 220: Member management unit
230: Product management unit 240: Electronic commerce unit
250: Fitting management unit 251: Avatar information input unit
252: Product information input unit 253: Product information analysis unit
254: Artificial intelligence fitting unit 255: Fitting evaluation unit
300: Seller terminal 400: Manufacturer terminal
500: SNS server 600: User
610: User avatar 700, 700a: Product
710, 710a: Product tag 800, 800a, 800b: Information display means
900: Online advertising information 900a, 900b: Outdoor advertising information

1. An electronic commerce service system using a virtual fitting function, the electronic commerce service system comprising:
a user terminal (100) configured to access a transaction service server (200) to perform electronic commerce for a product provided from an arbitrary seller terminal (300), analyze user body information from a captured image of a user (600)'s body to generate a user avatar (610), and display a virtual fitting image provided from the transaction service server (200);
the transaction service server (200) configured to manage electronic commerce performed between the seller terminal (300) selling an arbitrary product and the user terminal (100), and, in case that a request for fitting of a product is made from the user terminal (100), receive user avatar (610) information and product specification information, which comprises color, product design information, size information, function information, material information, and elasticity information related to the product, from the user terminal (100) and the seller terminal (300) to generate a virtual fitting image, perform fitting through simulation corresponding to the user's physical wearing state by reflecting the size information, the function information, the material information, the elasticity information, and wrinkle information included in the product specification information in product deformation according to the user avatar (610)'s movement through an artificial intelligence-based fitting prediction model, analyze and predict a physical wearing state through fitting, the physical wearing state referring to a state in which the product is stretched or wrinkled due to the user directly wearing the product, and generate a virtual fitting image in which the physical wearing state is reflected in the user avatar (610), the virtual fitting image being generated by reflecting arbitrary background and environmental images in the user avatar (610) during a fitting simulation reflecting the product specification information, analyze a product deformation state, based on the virtual fitting image, depending on the product's size and the product's size, function, material, elasticity, and wrinkle according to the user avatar (610)'s movement, and generate and output product fitting evaluation information based on a deformation result of the product; and
the seller terminal (300) configured to access the transaction service server (200), provide at least one product and product information of the product, and perform electronic commerce for the product with the user terminal (100).

2. The electronic commerce service system of claim 1, wherein the user terminal (100) comprises:
an input unit (110) configured to receive user information and electronic commerce information from the user (600);
a 3D measurement unit (120) configured to capture an image of the user (600)'s body and output the image as a three-dimensional image;
a display unit (130) configured to output the captured three-dimensional image, the user avatar (610), and the virtual fitting image provided by the transaction service server (200);
a control unit (140) configured to execute an avatar generation application program to analyze an object from three-dimensional image information of the 3D measurement unit (120), generate a user avatar (610) by reflecting depth information of the analyzed object as the user body information, execute an electronic commerce application program to request product fitting from the transaction service server (200), and control electronic commerce to be performed with the seller terminal (300); and
a data communication unit (150) configured to transmit and receive the user information, the electronic commerce information, the user avatar (610) information, fitting request information, and the virtual fitting image.

3. The electronic commerce service system of claim 2, wherein the user terminal (100) further comprises an imaging unit (160) configured to photograph a one-dimensional or two-dimensional information display means displaying arbitrary product information, and
wherein the control unit (140) is configured to analyze seller information and product information from the photographed information display means, request product fitting based on the product information from the transaction service server (200), and control electronic commerce based on the seller information to be performed with the seller terminal (300).

4. The electronic commerce service system of claim 3, wherein the 3D measurement unit (120) is configured to calculate depth information relative to an object by using either SL (structured light) or ToF (time of flight), and output the user's body size information, based on the calculated depth information.

5. The electronic commerce service system of claim 3, wherein the control unit (140) is configured to correct the generated user avatar (610) by using a digital twin program and store the correction result in the user terminal (100).

6. The electronic commerce service system of claim 1, wherein the transaction service server (200) comprises:
data communication unit (210) configured to transmit and receive user information, electronic commerce information, user avatar (610) information, fitting request information, seller information, product information comprising product specification information, and virtual fitting image information with at least one of the user terminal (100), the seller terminal (300), a manufacturer terminal (400), and an SNS server (500) ;
a member management unit (220) configured to manage user authentication and seller authentication, based on the user information and the seller information;
a product management unit (230) configured to store the product information and product specification information comprising product design information comprising color, size information, function information, material information, elasticity information, and wrinkle information;
an electronic commerce unit (240) configured to manage electronic commerce for an arbitrary product performed between the user terminal (100) and the seller terminal (300); and
a fitting management unit (250) configured to perform, in case that a request for fitting of a product is made from the user terminal (100), fitting through a simulation corresponding to the user's physical wearing state by reflecting the size information, the function information, the material information, the elasticity information, and wrinkle information included in the product specification information in product deformation according to the user avatar (610)'s movement by using an artificial intelligence-based fitting prediction model, based on user avatar (610) information and product information received from the user terminal (100) and the seller terminal (300), product specification information of the product stored in the product management unit (230) and arbitrary background and environmental information during a fitting simulation reflecting the product specification information, generate a corrected user avatar (610) reflecting product deformation prediction information corresponding to a physical wearing state through the fitting, render the corrected user avatar (610) photorealistically by using a photorealistic rendering model, generate the photorealistically rendered user avatar (610) as a virtual fitting image, analyze a product deformation state, based on the virtual fitting image, depending on the product's size and the product' size, function, material, elasticity, and wrinkle according to the user avatar (610)'s movement, and generate and output product fitting evaluation information based on a deformation result of the product.

7. The electronic commerce service system of claim 6, wherein the fitting management unit (250) comprises:
an avatar information input unit (251) configured to receive user avatar (610) information from the user terminal (100) in case that a request for fitting of a product is made;
a product information input unit (252) configured to receive the product information and the product specification information;
a product information analysis unit (253) configured to analyze product design information comprising color, size information, function information, material information, and elasticity information from the product specification information;
an artificial intelligence fitting unit (254) configured to generate a virtual fitting image by using an artificial intelligence-based fitting prediction model, perform fitting through a simulation corresponding to the user's physical wearing state by reflecting size information, function information, material information, elasticity information, and wrinkle information in product specification information according to the user avatar (610)'s movement, based on the product specification information and arbitrary background and environmental information during a fitting simulation reflecting the product specification information, correct the user avatar (610) by reflecting product deformation prediction information corresponding to the physical wearing state through the fitting, render the corrected user avatar (610) photorealistically by using a photorealistic rendering model, and generate the photorealistically rendered user avatar (610) as a virtual fitting image; and
a fitting evaluation unit (255) configured to analyze a product deformation state, based on the virtual fitting image, depending on the product's size and the product's size, function, material, elasticity, and wrinkle according to the user avatar (610)'s movement, and convert the product fitting evaluation information based on the deformation result of the product into an arbitrary format and output the converted information.

8. The electronic commerce service system of claim 7, wherein the artificial intelligence fitting unit (254) is configured to identify whether SNS information is input from the user terminal (100), transmit the generated virtual fitting image to the SNS server (500) corresponding to the SNS information in case that the input of the SNS information is identified, and output response information received from the SNS server (500) to the fitting evaluation unit (255).

9. The electronic commerce service system of claim 7, wherein the fitting evaluation unit (255) is configured to additionally generate product customizing information, based on the generated fitting evaluation information and output the customizing information to the user terminal (100).

10. The electronic commerce service system of claim 9, wherein the fitting evaluation unit (255) is configured to, in case that a purchase request corresponding to the customizing information is input from the user terminal (100), request electronic commerce by transmitting the customizing information for custom manufacturing, user information, and product specification information to the manufacturer terminal (400) via the electronic commerce unit (240).

11. An electronic commerce service method using a virtual fitting function, the electronic commerce service method comprising:
step a) in which a user terminal (100) analyzes user body information from a captured image of a user (600)'s body to generate a user avatar (610);
step b) in which the user terminal (100) accesses a transaction service server (200) to perform electronic commerce for a product provided from an arbitrary seller terminal (300);
step c) in which the transaction service server (200) manages electronic commerce performed between the user terminal (100) and the seller terminal (300), determines whether a request for fitting of a product is made from the user terminal (100), and in case that the request for fitting the product is made, the transaction service server (200) receives user avatar (610) information and product specification information, which comprises color, product design information, size information, function information, material information, and elasticity information related to the product, from the user terminal (100) and the seller terminal (300);
step d) in which the transaction service server (200) performs fitting through a simulation corresponding to the user's physical wearing state by reflecting the size information, the function information, the material information, the elasticity information, and wrinkle information included in the product specification information in product deformation according to the user avatar (610)'s movement through an artificial intelligence-based fitting prediction model, generates a corrected user avatar (610) reflecting product deformation prediction information corresponding to a physical wearing state through the fitting, renders the corrected user avatar (610) photorealistically by using a photorealistic rendering model, and generates the photorealistically rendered user avatar (610) as a virtual fitting image; and
step e) in which the transaction service server (200) analyzes a product deformation state, based on the virtual fitting image, depending on the product's size and the product' size, function, material, elasticity, and wrinkle according to the user avatar (610)'s movement, and generate and output product fitting evaluation information based on a deformation result of the product.

12. The electronic commerce service method of claim 11, wherein the step a) comprises:
a body scanning step a-1) in which the user terminal (100) captures an image of the user (600)'s body and outputs the image as a three-dimensional image; and
a step a-2) in which the user terminal (100) analyzes an object from the captured three-dimensional image information, generates a user avatar (610) reflecting depth information of the analyzed object as the user body information, corrects the user avatar (610) by using a digital twin program, and stores the user avatar (610) reflecting the correction result in the user terminal (100).

13. The electronic commerce service method of claim 11, wherein the step b) further comprises a step in which the user terminal (100) photographs a one-dimensional or two-dimensional information display means displaying arbitrary product information,
analyzes seller information and product information from the photographed information display means, requests product fitting based on the product information from the transaction service server (200), and
performs electronic commerce based on the seller information with the seller terminal (300).

14. The electronic commerce service method of claim 11, wherein the step e) further comprises a step in which the transaction service server (200) identifies whether SNS information is input from the user terminal (100),
transmits the generated virtual fitting image to an SNS server (500) corresponding to the SNS information in case that the input of the SNS information is identified, and
reflects response information received from the SNS server (500) in the product fitting evaluation information.

15. The electronic commerce service method of claim 11, wherein, in the step e), the transaction service server (200) additionally generates product customizing information, based on the generated fitting evaluation information, and outputs the customizing information to the user terminal (100).

16. The electronic commerce service method of claim 15, further comprising step f) in which the transaction service server (200) determines whether a product order has been completed, and
in case that either the product's predefined information or customizing information is input from the user terminal (100), transmits product specification information for an electronic commerce unit (240), the customizing information for custom manufacturing, and user information to the seller terminal (300) or a manufacturer terminal (400) to perform the electronic commerce.
